(19) United States
(12) Patent Application Publication
(10) Pub. No.: US 2012/0189367 A1
(43) Pub. Date: Jul. 26, 2012

(54) PRINTER

(75) Inventors: Norihisa KOBAYASHI, Asahi-mura (JP); Kosaku NOBUTA, Suwa (JP)

(73) Assignee: SEIKO EPSON CORPORATION, Tokyo (JP)

(21) Appl. No.: 13/355,928

(22) Filed: Jan. 23, 2012

(30) Foreign Application Priority Data
Jan. 26, 2011 (JP) 2011-013752

(51) Int. Cl. B41J 19/70

(52) U.S. Cl. 400/319

(57) ABSTRACT

In a mechanism for conveying a carriage by a belt wound over a drive pulley and a driven pulley, the tension of the belt weakens and pull out occurs between the belt and the carriage. Provided is a printer in which a belt is wound over a drive pulley and a driven pulley and a carriage attached to the belt is operated, wherein the driven pulley is provided with a movement stopper for stopping the movement of the carriage.

### CROSS-REFERENCE TO RELATED APPLICATIONS

This application claims priority to Japanese Patent Application No. 2011-013752 filed on Jan. 26, 2011. The entire disclosure of Japanese Patent Application No. 2011-013752 is hereby incorporated herein by reference.

### BACKGROUND

1. Technical Field

The present invention relates to a printer wherein a carriage is moved back and forth by a belt.

2. Background Technology

In inkjet printers in the past, a carriage is attached to a belt wound over a drive pulley and a driven pulley, and rotatably driving the drive pulley causes the carriage following the belt to move back and forth. In the art in the past, tooth surfaces are commonly formed in the drive pulley, the driven pulley, and the belt, and the belt is made to properly follow the rotation of the drive pulley by the meshing of the teeth, but pull out and tooth skipping are caused by the action of the drive pulley. There is a known technique for suppressing pull out and tooth skipping by supporting the driven pulley by a driven pulley support member, and providing urging means for urging the driven pulley support member in the direction in which tension is applied to the belt (Patent Citation 1, for example).

Japanese Patent Application Publication No. 2008-30453 (Patent Citation 1) is examples of the related art.

### SUMMARY

### Problems to be Solved by the Invention

Even when the art described above has been used, it has been difficult to suppress pull out and tooth skipping caused by excessive drive force. For example, there are cases in inkjet printers wherein a prescribed initial action accompanying carriage positioning or the like is performed after the power source is added, and during this positioning an action is performed for moving the carriage from one end of the movement range to the other. However, when the power source is added in a state in which the carriage position is not specified due to an error such as the print medium being stuck in the conveying route, it is unclear how far the carriage should be moved to reach the end of the movement range, and cases therefore occur wherein the driving of the drive pulley cannot be stopped despite the carriage having reached the end of the movement range.

Even if the configuration features the art described above, the drive pulley is driven despite the carriage being unable to move in such cases, and a state arises wherein the drive force transmitted to the belt does not act as force that moves the carriage. Therefore, the drive force transmitted to the belt acts as force that brings the driven pulley support member closer to the drive pulley against the urging force of the urging means. As a result, the driven pulley draws near to the drive pulley together with the drive pulley support member, and pull out and tooth slipping occur because the belt loses tension. The invention was devised in view of the problems described above, and an advantage thereof is to provide a technique whereby pull out and tooth skipping can be prevented even in cases wherein drive force acts on the drive pulley in a state in which the carriage has reached the end of the movement range.

### Means Used to Solve the Above-Mentioned Problems

To achieve the advantage described above, a printer is provided in which a belt having tooth surfaces formed therein is wound over a drive pulley and a driven pulley having tooth surfaces formed therein, and a carriage is attached to the belt and thereby moved back and forth; wherein the driven pulley is rotatably supported by a driven pulley supporter, the driven pulley supporter is supported on a support member, and the driven pulley is thereby supported on the support member via the driven pulley supporter. Furthermore, the driven pulley supporter is capable of moving in an approaching direction which causes the driven pulley and the drive pulley to approach each other and a separating direction which causes the pulleys to separate from each other, and the driven pulley supporter is supported on the support member in a state in which force acts in the separating direction. In this configuration, the driven pulley supporter also has a movement stopper for stopping the carriage from moving away from the drive pulley toward the driven pulley.

Specifically, as the belt is driven, the carriage moves in a movement path from an end near the driven pulley to an end near the drive pulley, and the driven pulley supporter has a movement stopper for stopping the carriage from moving away from the drive pulley toward the driven pulley. Therefore, when the carriage reaches the movement stopper of the driven pulley supporter while the carriage is moving in the movement path away from the drive pulley toward the driven pulley, the movement of the carriage is stopped by the movement stopper.

In this case, when the movement of the carriage is stopped, force applied to the carriage away from the drive pulley toward the driven pulley is applied to the driven pulley supporter. The force away from the drive pulley toward the driven pulley acts on the driven pulley supporter as force in the separating direction which causes the drive pulley and the driven pulley to separate from each other. Therefore, when the carriage has reached the end near the driven pulley in the movement range, force in the separating direction continues to be applied to the driven pulley supporter by the carriage. When drive force acts on the drive pulley during a state in which the carriage has reached the end near the driven pulley in the movement range and the carriage is unable to move toward the driven pulley, the drive force transmitted to the belt possibly acts as force in the approaching direction which causes the drive pulley and the driven pulley to approach each other as described above. However, according to the invention, since the carriage causes force in the separating direction to act on the driven pulley supporter due to the carriage being stopped by the movement stopper, the carriage subjects the driven pulley to force that diminishes the force in the approaching direction described above. As a result, the driven pulley supporter and the driven pulley can both be prevented from approaching the drive pulley, tension loss in the belt can be prevented, and pull out and tooth skipping can be prevented.

The driven pulley supporter is capable of moving in an approaching direction which causes the driven pulley and the drive pulley to approach each other and a separating direction which causes the pulleys to separate from each other, and the driven pulley supporter is supported on the support member in a state in which force acts in the separating direction. Specifically, the configuration is preferably designed so that force in the separating direction acts on the driven pulley supporter, whereby tension is applied to the belt by the drive pulley and the driven pulley, and the carriage can be moved in the belt movement direction by the belt.

Various configurations can be used as the configuration for subjecting the driven pulley supporter to force in the separating direction which causes the drive pulley and the driven pulley to separate from each other. For example, in one possible configuration, force in the separating direction is applied to the driven pulley supporter by a spring attached at one end to the support member and attached at the other end to the driven pulley supporter. Specifically, the repulsion force of the spring increases as the displacement of the spring increases; therefore, if the configuration uses the spring, it is easy and preferable to maintain the belt tension against the force in the approaching direction even in cases in which the driven pulley supporter is subjected to force in the approaching direction, which is opposite the separating direction which causes the drive pulley and the driven pulley to separate from each other. By designing the configuration so that the movement of the carriage is stopped by the movement stopper, the force of the spring can be supplemented easily, and pull out and tooth skipping can be prevented easily. The spring is one example of a component for subjecting the driven pulley supporter to force in the separating direction which causes the drive pulley and the driven pulley to separate from each other, and other elastic members, e.g., rubber or the like, can be used as this component.

Furthermore, the movement stopper provided to the driven pulley supporter is preferably a member for stopping the carriage from moving away from the drive pulley toward the driven pulley. Specifically, since the belt is wound over the drive pulley and the driven pulley one end of the movement range of the carriage is near the driven pulley, and the other end is near the drive pulley. If the movement stopper is then formed on the driven pulley positioned near the one end of the carriage movement range, the movement of the carriage can be stopped at the end near the driven pulley of the carriage movement range. The movement stopper is preferably a member capable of stopping the movement of the carriage, and can be configured integrally with the driven pulley supporter or configured so as to be attached to the driven pulley supporter.

Various configurations can be used as the configuration for stopping the carriage by the movement stopper. For example, the configuration can be designed so that the movement stopper is disposed in the movement path of the carriage, the movement stopper comes in contact with the carriage when the carriage moves to the position where the movement stopper is located, and the carriage is restrained from moving. As an example of the configuration for disposing the movement stopper in the movement path of the carriage, a configuration can be used in which the movement stopper is formed by a protrusion that protrudes from the driven pulley supporter into the movement path of the carriage, for example.

According to this configuration, the movement stopper for stopping the carriage can be configured simply by providing a protrusion to the driven pulley supporter for supporting the driven pulley, and the movement stopper can be configured by a simple configuration. Of course, the configuration of the movement stopper is not limited to a protrusion provided to the driven pulley supporter, and various other configurations can be used. For example, while the carriage is moving away from the drive pulley toward the driven pulley, a protrusion protruding from the carriage can come in contact with the driven pulley supporter and stop the movement of the carriage. In this configuration, the movement stopper is constituted by the top surface of the driven pulley supporter contacted by the protrusion protruding from the carriage.

Furthermore, the procedure whereby the movement stopper for stopping the movement of the carriage is provided to the driven pulley supporter for rotatably supporting the driven pulley as in the invention can also be applied as a method. While there are cases in which the device and method described above are implemented as a single device, there are also cases in which shared components are used and implemented in a device having multiple functions, and such cases include various embodiments.

### BRIEF DESCRIPTION OF THE DRAWINGS

Referring now to the attached drawings which form a part of this original disclosure:

FIG. 1A is a drawing showing the printer according to an embodiment of the invention, 1B is a front view of the drive mechanism of the carriage, 1C is a front view showing a state in which the support member has been removed from 1B, and 1D is a drawing showing the driven pulley, the driven pulley supporter, and the spring in a disassembled state; and

FIG. 2A is a top view showing a state in which the support member has been removed from 1B, 2B is a drawing showing the driven pulley, the driven pulley supporter, and the spring in a disassembled state, 2C is a front view of the support member, and 2D is a top view of the support member.

### DETAILED DESCRIPTION OF EXEMPLARY EMBODIMENTS

An embodiment of the invention is described in the following order.

(1) Configuration of Printer:

(2) Drive Mechanism of Carriage:

### (1) Configuration of Printer:

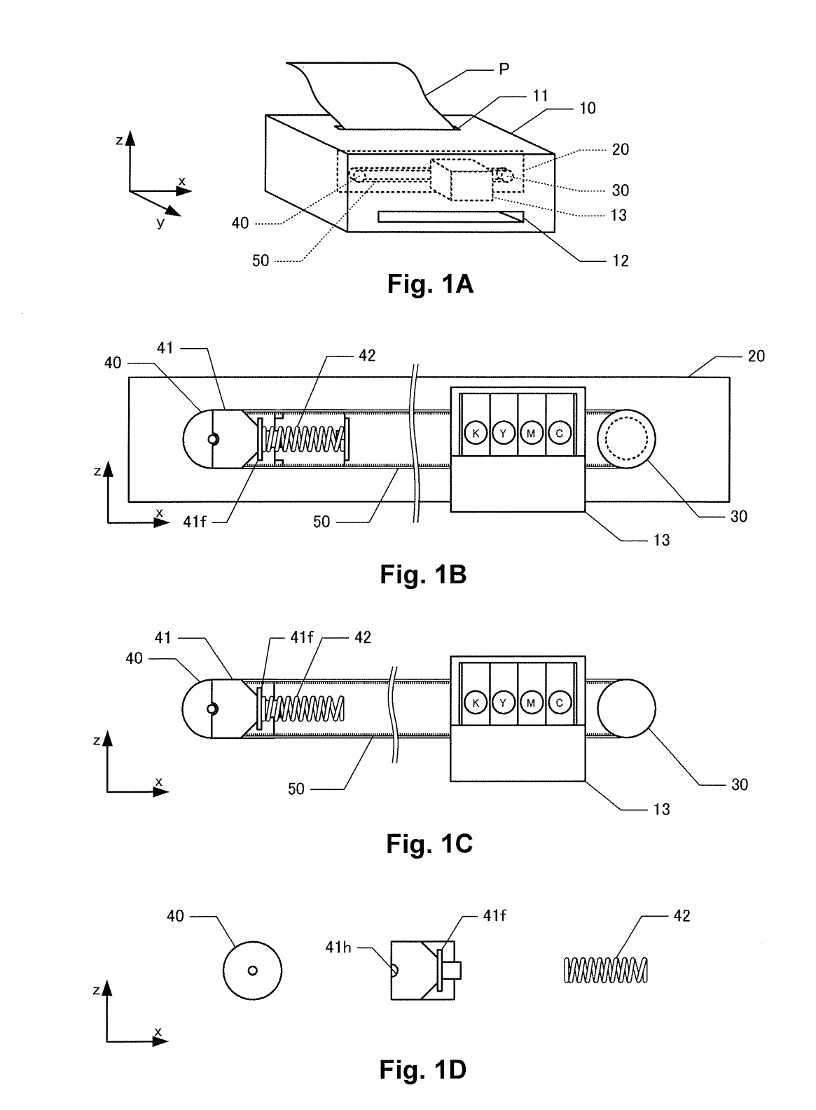

FIG. 1A is a drawing showing the schematic configuration of a printer 10 according to an embodiment of the invention. In FIG. 1A, a perspective view of the casing of the printer 10 is shown in a three-dimensional space including an x-axis, a y-axis, and a z-axis. Specifically, the printer 10 has a substantially rectangular parallelepiped casing, and when the printer 10 is placed on a horizontal surface, the surface provided with an insertion slot 11 for a print medium P is oriented parallel to the horizontal surface, and the surface provided with an ejection slot 12 for the print medium P is oriented perpendicular to the horizontal surface. In view of this, in this specification, the x-axis, y-axis, and z-axis are set so that the surface provided with the insertion slot 11 and the x-y plane are parallel, while the x-z plane is parallel with the surface provided with the insertion slot 11. Furthermore, the edges of the casing of the printer 10 are oriented parallel with the respective x-axis, y-axis, and z-axis.

The printer 10 according to the present embodiment is capable of conveying the print medium P inserted through the insertion slot 11 for the print medium P and ejecting the print medium P through the ejection slot 12. In the interior thereof, the printer 10 also has a carriage 13 and a mechanism for moving the carriage. The mechanism for moving the carriage includes, inside the printer 10, a support member 20 fixed relative to the casing of the printer 10, a drive pulley 30 and driven pulley 40 supported on the support member 20, and a belt 50 wound around the drive pulley 30 and the driven pulley 40.

The support member 20 is a plate-shaped member oriented in a direction parallel to the x-z plane, and the drive pulley 30 and driven pulley 40 are supported to be capable of rotating relative to the support member 20. In the present embodiment, the drive pulley 30 is supported directly on the support member 20, and the driven pulley 40 is supported indirectly on the support member 20 via a driven pulley supporter 41. The driven pulley supporter 41 is described hereinafter.

The carriage 13 is attached to the belt 50 wound around the drive pulley 30 and driven pulley 40, and by rotatably driving the drive pulley 30, the belt can be moved back and forth in a direction parallel to the x-axis direction to move the carriage 13 back and forth in a direction parallel to the x-axis direction. The drive pulley 30 and the driven pulley 40 are disposed at the ends of the support member 20 in a direction parallel to the x-axis direction. Specifically, the drive pulley 30 is supported on the support member 20 at one end along the x-axis direction, the driven pulley 40 is supported on the support member 20 at the other end along the x-axis direction, and the print medium P is conveyed in a direction parallel to the y-axis direction between the drive pulley 30 and the driven pulley 40. Therefore, images and the like can be printed on the print medium P by moving the carriage 13 back and forth in a direction parallel to the x-axis direction while the print medium P is being conveyed, and discharging ink from an ink head mounted on the carriage 13.

### (2) Drive Mechanism of Carriage:

In the present embodiment, in the printer 10 described above, tension in the belt 50 is maintained by a spring, and the drive mechanism of the carriage is configured so that even under conditions in which force opposing the repulsion force of the spring can be transmitted to the belt 50, pull out and tooth skipping do not occur between the belt 50 and the drive pulley 30 and driven pulley 40. The drive mechanism of the carriage is described in detail hereinbelow.

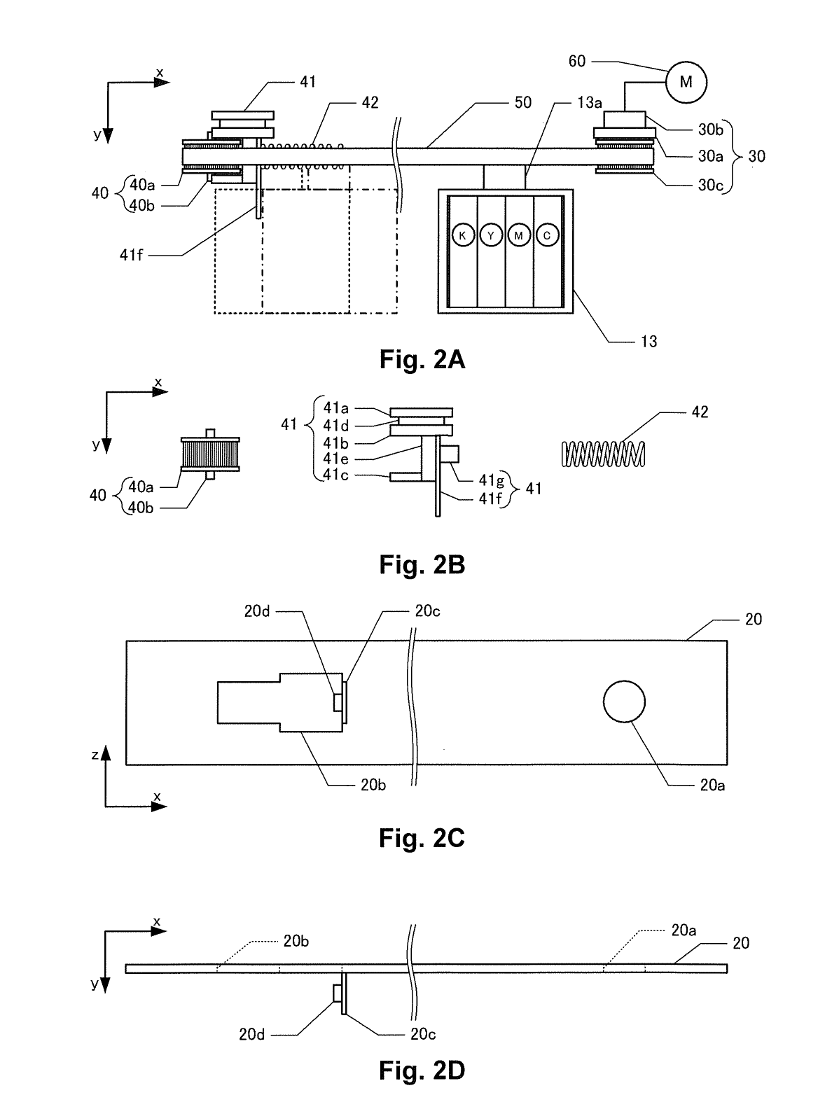

FIG. 1B is a front view as seen from a direction parallel to the y-axis direction with the drive mechanism of the carriage omitted, FIG. 1C is a front view as seen from a direction parallel to the y-axis direction with the support member 20 removed from FIG. 1B, and FIG. 1D is a drawing showing a state in which the driven pulley 40, the driven pulley supporter 41 for supporting the driven pulley 40, and a spring 42 attached to the driven pulley supporter 41 are disassembled and viewed from a direction parallel to the y-axis direction. FIG. 2A is a top view as seen from a direction parallel to the z-axis direction with the support member 20 removed from FIG. 1B, and FIG. 2B is a drawing showing a state in which the driven pulley 40, the driven pulley supporter 41, and the spring 42 are disassembled and viewed from a direction parallel to the z-axis direction. FIG. 2C is a front view of the support member 20, as seen from a direction parallel to the y-axis direction, and FIG. 2D is a top view of the support member 20 as seen from a direction parallel to the z-axis direction.

The drive pulley 30 includes a flange 30a, a cylindrical part 30b, and a rotating member 30c as shown in FIG. 2A, and the rotating member 30c is attached to be capable of rotating relative to a rotating shaft (not shown) extending from the flange 30a in a direction opposite the cylindrical part 30b. A hole 20a is formed in one end of the support member 20 in a direction along the x-axis (see FIG. 2C), the cylindrical part 30b of the drive pulley 30 is inserted into the hole 20a of the support member 20, and the drive pulley 30 is supported on the support member 20. The rotating member 30c can rotate in a state in which the drive pulley 30 is supported on the support member 20, and the drive pulley 30 is supported to be capable of rotating relative to the support member 20.

Concavities and convexities extending in a direction parallel to the rotating shaft of the rotating member 30c are formed in the external peripheral portion of the rotating member 30c. Specifically, tooth surfaces are formed in the external periphery of the rotating member 30c. The printer 10 is provided with a motor 60, and the motor 60 is connected to the drive pulley 30. Therefore, by causing the motor 60 to rotate in a predetermined direction or the opposite direction, the drive pulley 30 can be rotated clockwise or counterclockwise in FIG. 1B.

The driven pulley 40 is provided with a rotating member 40a and a rotating shaft 40b as shown in FIG. 2B etc., and tooth surfaces are formed in the external peripheral portion of the rotating member 40a by concavities and convexities extending in a direction parallel to the rotating shaft 40b of the rotating member 40a.

The driven pulley supporter 41 is provided with plate-shaped members 41a to 41c and linking parts 41d, 41e as shown in FIG. 2B etc., and with the plate-shaped members 41a to 41c oriented in parallel, the plate-shaped members 41a to 41c are linked by the linking parts 41d, 41e extending perpendicular from the plate-shaped members 41a to 41c. Furthermore, the driven pulley supporter 41 is provided with a movement stopper 41f and a spring bearing 41g, and the movement stopper 41f is a plate-shaped member attached to the plate-shaped member 41c and linking part 41e in a state of being oriented perpendicular to the plate-shaped member 41b. The spring bearing 41g is cylindrical and is configured by being attached to the movement stopper 41f so as to extend perpendicular from the movement stopper 41f.

In the present embodiment, the largest surface of the movement stopper 41f is oriented parallel to the z-y plane, and the spring bearing 41g is attached to the movement stopper 41f so as to be oriented parallel to the x-axis. The outside diameter of the spring bearing 41g is configured so as to be slightly smaller than the inside diameter of the spring 42, and the spring 42 can be fitted over the spring bearing 41g.

In the support member 20, a hole 20b is formed in the end at the side opposite the drive pulley 30. The shape of this hole 20b is such that rectangular holes of different sizes are aligned and connected in the x-axis direction, and the hole 20b is formed so that the portion equivalent to the larger rectangular hole (the portion positioned on the right side in the hole 20b of the support member 20 shown in FIG. 2C) is larger than the external peripheries of the plate-shaped members 41a, 41b (the external peripheries when viewed from the x-z plane (e.g., the external peripheries in FIG. 1D)). The hole 20b is also formed so that the portion equivalent to the smaller rectangular hole (the portion positioned on the left side in the hole 20b of the support member 20 shown in FIG. 2C) is smaller than the external peripheries of the plate-shaped members 41a, 41b. Furthermore, the distance between the plate-shaped member 41a and the plate-shaped member 41b is slightly greater than the thickness of the support member 20 in a direction parallel to the y-axis direction.

Therefore, part of the driven pulley supporter 41 is inserted through the larger rectangular portion of the hole 20b and the driven pulley supporter 41 is slid into the smaller rectangular portion of the hole 20b while the support member 20 is held between the plate-shaped members 41a, 41b, whereby the driven pulley supporter 41 is supported on the support member 20. In this state, the driven pulley supporter 41 can be moved back and forth in a direction parallel to the x-axis direction.

Furthermore, in the support member 20, a plate-shaped member 20c is connected along the edge of the hole 20b that is closest to the hole 20a (see FIGS. 2C and 2D). The plate-shaped member 20c is perpendicular to the x-z plane and parallel to the y-z plane, and a cylindrical spring bearing 20d is connected thereto. The spring bearing 20d is oriented so that the axis thereof is parallel to the x-axis and the spring bearing 20d protrudes into the hole 20b, the outside diameter of the spring bearing 20d is slightly smaller than the inside diameter of the spring 42, and the spring 42 can be fitted over the spring bearing 20d.

Therefore, with the driven pulley supporter 41 being supported on the support member 20 so as to be capable of moving back and forth in a direction parallel to the x-axis direction as described above, by inserting the spring bearing 41g through one end of the spring 42 and inserting the spring bearing 20d through the other end of the spring 42, the spring 42 can be held between the driven pulley supporter 41 and the plate-shaped member 20c as shown in FIG. 1B. The present embodiment is configured so that the spring 42 is held between the driven pulley supporter 41 and the plate-shaped member 20c while in a compressed state. Therefore, the repulsion force of the spring 42 acts as force that urges the driven pulley supporter 41, which is capable of moving back and forth within the hole 20b, toward the left of FIG. 1B.

Furthermore, semicircular bearings 41h are formed in the plate-shaped members 41b, 41c provided to the driven pulley supporter 41 (see FIG. 1D). The bearings 41h have inside diameters slightly larger than the outside diameter of the rotating shaft 40b provided to the driven pulley 40. Therefore, the rotating shaft 40b of the driven pulley 40 can be fitted into the bearings 41h of the driven pulley supporter 41. With the spring 42 held between the driven pulley supporter 41 and the plate-shaped member 20c as described above, the driven pulley supporter 41 is restrained by the repulsion force of the spring 42 from moving toward the drive pulley 30.

In view of this, when the belt 50 having tooth surfaces formed therein is installed so as to mesh with the tooth surfaces provided to the driven pulley 40 and the drive pulley 30 during a state in which the rotating shaft 40b of the driven pulley 40 is fitted in the bearings 41h of the driven pulley supporter 41, the belt 50 can be tightened so as not to fall off the driven pulley 40 or the drive pulley 30. In this case, the driven pulley 40 is held in a state in which it does not fall off the driven pulley supporter 41, and the driven pulley 40 is therefore rotatably supported on the driven pulley supporter 41.

In the present embodiment, the carriage 13 has a plate-shaped member 13a (see FIG. 2A), and the plate-shaped member 13a is attached to the belt 50 located underneath. Furthermore, in the present embodiment, the spring 42 is designed with a spring constant that creates tension capable of moving the carriage 13 in the belt 50. Therefore, when the drive pulley 30 is moved clockwise or counterclockwise in FIG. 1B by rotating the motor 60 in a predetermined direction or the opposite direction, the carriage 13 can be moved back and forth in a direction parallel to the x-axis direction.

As described above, the driven pulley 40 is supported on the support member 20 via the driven pulley supporter 41, and the driven pulley supporter 41 is urged to the left in FIG. 1B by the spring 42. In the support member 20, the drive pulley 30 is supported in the end on the side opposite the driven pulley 40 (the right side in FIG. 1B). Furthermore, the driven pulley supporter 41 is capable of moving back and forth along a direction parallel to the x-axis direction (capable of moving left and right in FIG. 1B) in the hole 20b of the support member 20. Therefore, the driven pulley supporter 41 is capable of moving in an approaching direction which causes the driven pulley 40 and the drive pulley 30 to approach each other and a separating direction which causes the pulleys to separate from each other, and the driven pulley supporter 41 is supported on the support member 20 in a state in which force acts in the separating direction.

The printer 10 according to the present embodiment controls the rotational drive force of the motor 60 and moves the carriage 13, but usually prints by moving the carriage 13 within a pre-established movement range while specifying the position of the carriage 13. However, in cases such as when errors occur such as the print medium P being stuck in the conveying route, or when the power source is turned off while the printer 10 has stopped operating and then the power source is turned back on, the position of the carriage 13 will sometimes be unclear. In these cases, when the position of the carriage 13 remains unclear, the position of the carriage 13 is specified by moving the carriage 13 at first to the end of the movement range, and the usual operation is resumed after the position has been specified.

When the carriage 13 is caused to move while the position thereof remains unclear, drive force from the motor 60 could possibly act on the drive pulley 30 despite the carriage 13 actually being positioned at the end of the movement range and being unable to move any further. In this case, the drive force transmitted to the belt 50 does not act as force that moves the carriage 13, but the drive force transmitted to the belt 50 acts as force that moves the driven pulley supporter 41 in the approaching direction against the repulsion force of the spring 42. When the driven pulley supporter 41 is moved in the approaching direction by force acting in the approaching direction, the driven pulley supporter 41 and the driven pulley 40 both approach the drive pulley 30, and pull out or tooth skipping occurs because the belt 50 loses tension.

When the spring 42 is used in order to urge the driven pulley supporter 41 in the separating direction as in the present embodiment, the repulsion force of the spring 42 increases in proportion to the displacement of the spring 42, and it is therefore easy and preferable to maintain the tension of the belt against the force in the approaching direction when the carriage 13 cannot be moved and force in the approaching direction acts on the driven pulley supporter 41. However, using only the repulsion force of the spring 42, it is actually not possible to prevent pull out and tooth skipping, for reasons such as the need for the spring constant of the spring 42 to be extremely high in order to prevent pull out and tooth skipping when the carriage 13 cannot be moved.

In view of this, in the present embodiment, pull out and tooth skipping are prevented by stopping the carriage 13 from moving away from the drive pulley 30 toward the driven pulley 40 with the movement stopper 41f. Specifically, by providing the driven pulley supporter 41 with the movement stopper 41f protruding into the movement path of the carriage 13, when the end of the carriage 13 reaches the movement stopper 41f while the carriage 13 is moving away from the drive pulley 30 toward the driven pulley 40, the carriage 13 is stopped so as to be unable to move any further. The carriage 13 in the example shown in FIG. 2A does not move to the position shown by the dashed lines near the driven pulley 40, but stops at the position shown by the single-dotted lines near the driven pulley 40.

Thus, when the movement of the carriage 13 is stopped by the movement stopper 41f, the force acting on the carriage 13 is transmitted to the driven pulley supporter 41, and force in the separating direction acts on the driven pulley supporter 41. While drive force for moving the carriage 13 in the same direction continues to act on the belt 50 from the motor 60, force in the separating direction continues to be applied to the driven pulley supporter 41 by the carriage 13.

When drive force for moving the carriage 13 continues to act on the belt 50 from the motor 60 while the carriage 13 remains stopped, the drive force transmitted to the belt 50 acts as force that moves the driven pulley supporter 41 in the approaching direction against the repulsion force of the spring 42. However, in the present embodiment, the carriage 13 is stopped by the movement stopper 41f, whereby force in the separating direction continues to act on the driven pulley supporter 41. Therefore, the driven pulley supporter 41 and the driven pulley 40 can both be prevented from approaching the drive pulley 30, tension loss in the belt 50 can be prevented, and pull out and tooth skipping can be prevented.

What is claimed is:

1. A printer comprising:
a motor;
a support member;
a drive pulley rotatably supported on the support member, tooth surfaces rotatably driven by the motor being formed in the drive pulley;
a driven pulley having tooth surfaces formed therein;
a driven pulley supporter for rotatably supporting the driven pulley; and
a belt wound around the drive pulley and the driven pulley; wherein the driven pulley supporter has a movement stopper for stopping the carriage from moving away from the drive pulley toward the driven pulley.

2. The printer according to claim 1, wherein
the movement stopper protrudes from the driven pulley supporter into the movement path of the carriage.

3. The printer according to claim 1, wherein
the driven pulley supporter is capable of moving in an approaching direction which causes the driven pulley and the drive pulley to approach each other and a separating direction which causes the pulleys to separate from each other, and the driven pulley supporter is supported on the support member in a state in which force acts in the separating direction.

4. The printer according to claim 3, wherein
force is applied to the driven pulley supporter in the separating direction by a spring attached at one end to the support member and attached at the other end to the driven pulley supporter.

5. The printer according to claim 1, wherein
tooth surfaces are formed in the belt, and tooth surfaces that mesh with the tooth surfaces formed in the belt are formed in the drive pulley and the driven pulley.
